(19) United States
(12) Patent Application Publication
(10) Pub. No.: US 2013/0103610 A1
(43) Pub. Date: Apr. 25, 2013

(54) METHOD OF DAILY RECONCILIATION OF PARTICIPANT BENEFITS FOR A DEFINED BENEFIT PLAN

(71) Applicants: Jeffrey W. STEVENSON, Inverness, IL (US); Richard P. GROSSMAN, Los Angeles, CA (US); Christopher D. KIM, Littleton, CO (US); Joseph M. WOLLSCHEID, Keller, TX (US); Jeffrey J. BERENDS, Sedalia, CO (US); Richard A. BECKER, Grayslake, IL (US)

(72) Inventors: Jeffrey W. STEVENSON, Inverness, IL (US); Richard P. GROSSMAN, Los Angeles, CA (US); Christopher D. KIM, Littleton, CO (US); Joseph M. WOLLSCHEID, Keller, TX (US); Jeffrey J. BERENDS, Sedalia, CO (US); Richard A. BECKER, Grayslake, IL (US)

(21) Appl. No.: 13/280,016

(22) Filed: Oct. 24, 2011

(51) Int. Cl. G06Q 40/06

(52) U.S. Cl. 705/36 R

(57) ABSTRACT

A method and software for daily reconciling and monitoring of a defined benefit plan including plan assets and plan benefit liabilities. A data processor receives a daily plan asset value and automatically tracks a difference between the plan asset value and allowed benefit values for participants of the defined benefit plan. The method further includes automatic posting of the difference to a side account with the data processor.

### FIELD OF THE INVENTION

This invention relates to a method for active and automated reconciling of and tracking values within a defined benefit plan periodically, such as daily, during a plan year, and a system for implementing the method.

### BACKGROUND OF THE INVENTION

There are two general deferred compensation plans available for accumulating money for reasons such as retirement. Defined contribution plans, such as a 401(k) plan, allow an employee to save money by depositing into the plan a defined contribution, which is based solely on a percentage of the participant's current year earnings, subject to a maximum contribution limit. A defined benefit plan is designed to provide a party with a specific benefit at retirement. For a defined benefit plan, actuarial calculations are generally needed to determine annual contributions that are required to provide the benefit. The calculations typically take into account the party's age, years of service, and average earnings over several years.

Depending on a party's age and compensation history, tax laws and regulations may allow the party to make relatively larger tax-deferred annual contributions to a defined benefit plan than to a defined contribution plan. However, establishing a defined benefit plan generally requires an experienced actuary to determine, based upon factors such as age and compensation, contribution limits for a particular party. Moreover, the party must contact the actuary each year when final compensation and/or profit amounts are known in order to determine the party's actual pension contribution for the year. Shortfalls, namely mismatches between current plan benefit liabilities and current plan assets, can come as a surprise to the party at these annual reviews.

There is a need for a simplified system for monitoring a defined benefit plan and keeping a party updated on the assets of a defined benefit plan. By providing information on plan assets and liabilities during a plan year, a party can more reasonably account for or plan for shortfalls or overages in the defined benefit plan.

### SUMMARY OF THE INVENTION

A general object of the invention is to provide an automated method and system for reconciling defined benefit plans on a daily basis to allow for periodic review of assets and liabilities. A more specific objective of the invention is to overcome one or more of the problems described above.

The general object of the invention can be attained, at least in part, through a method of reconciling a defined benefit plan including plan assets and plan benefit liabilities. The method includes: receiving with a data processor a plan asset value at the end of a predetermined time period; automatically tracking with the data processor a difference between the plan asset value and allowed benefit values for participants of the defined benefit plan; and automatically posting with the data processor the difference to a side account with the data processor.

The invention further comprehends a method of reconciling a defined benefit plan including plan assets and benefit liabilities, including: providing for a participant a participant benefit account including a corresponding participant value comprising at least an allocated portion of the plan assets; receiving a plan asset value at an end of a predetermined time period with the data processor; automatically updating the participant value of the participant benefit value as a function of the received plan asset value; automatically determining any difference of updated participant amount over or under an allowed benefit value for the participant according to the defined benefit plan; and automatically posting the any difference from the participant benefit account to a side account.

The invention still further comprehends a computer system and/or software for performing the method of this invention. The method can be implemented by a data processor following processor executable software code instructions for implementing the method. The software can be stored on a computer readable medium, such as a hard drive, solid state or flash drive, or CD-ROM or DVD-ROM, associated with the data processor, either integrally or over a network. The data processor and software can provide a graphical user interface, such as through a monitor or mobile device, for providing information on plan asset values and other benefit and asset information reconciled by the method of this invention.

As used in this specification and the claims, references to a “defined contribution plan” are to be understood to refer to a retirement plan that provides for an individual account for each participating party and the benefit is based solely on the amount, and any income, expense, gains and/or losses, that are allocated to the party's account.

As used in this specification and the claims, references to a “defined benefit plan” are to be understood to refer to a plan that provides for a specified retirement benefit as of a specified retirement date. In other words, the benefit is defined, not the amount that must be contributed. Defined benefit plan assets are not held in individual accounts for each participating party as in a defined contribution plan, but rather are commingled in a plan level trust account. The contribution is generally determined according to governing tax laws and/or regulations.

Other objects and advantages will be apparent to those skilled in the art from the following detailed description taken in conjunction with the appended claims and drawings.

### BRIEF DESCRIPTION OF THE DRAWINGS

FIG. 1 is a representative flow diagram illustrating a method according to one embodiment of this invention.

FIG. 2 is a general representation of a system for implementing the method according to one embodiment of this invention.

FIG. 3 is a representative flow diagram illustrating a method according to another embodiment of this invention.

FIG. 4 is an exemplary user interface display according to one embodiment of this invention.

### DETAILED DESCRIPTION OF THE PRESENTLY PREFERRED EMBODIMENTS

This invention includes a computer-implemented method for automatically updating and/or reconciling a defined benefit plan based upon plan asset information received during a predetermined period, such as daily, weekly, monthly, quarterly, annually, or at any of a plurality of predetermined times during a plan year. As used herein, “plan year” refers to a yearly period established by the rules of the defined benefit plan. The method of this invention allows for monitoring of a defined benefit plan throughout a plan year, instead of an annual review of assets and liabilities at or after the end of the plan year. The method of this invention reduces or eliminates many, if not all, of the problems and inconveniences, such as surprise shortfalls or overages in plan funding that can occur with current annual plan reviews.

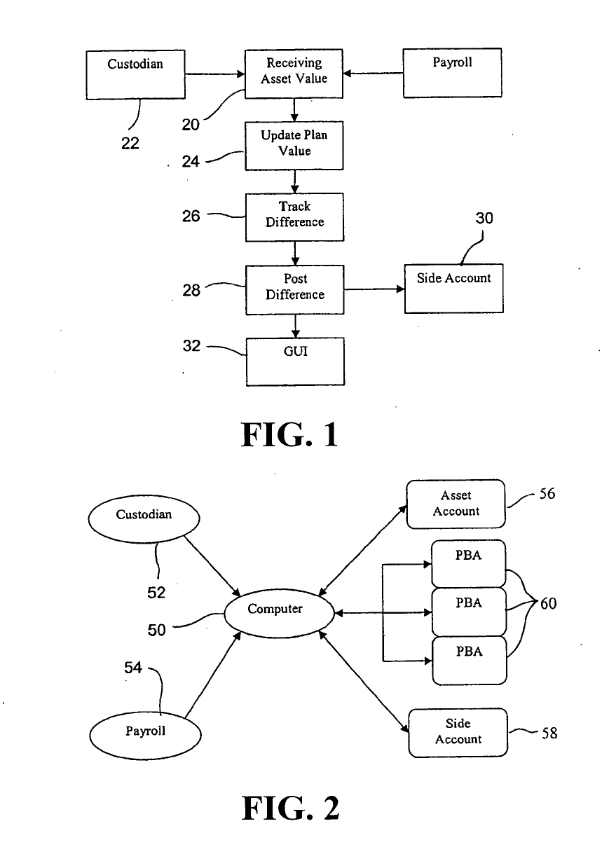

FIG. 1 shows a flow diagram of a method of reconciling a defined benefit plan according to one embodiment of this invention. The defined benefit plan is established according to plan rules, subject to government tax regulations, and includes plan assets, which are formed by employer contributions and interest and/or investment returns, and plan benefit liabilities, which include current and/or future benefits (e.g., distributions) owed to participants (e.g., employees) of the defined benefit plan. The method illustrated in FIG. 1 is implemented by a data processor associated with a recordable medium including the software instructions for performing the method and including data needed for implementing the method and data resulting from the method.

In box 20, the data processor receives a plan asset value at the end of a predetermined time period. The plan asset value is received from custodian 22, which holds and/or invests the plan assets, and which can be the same or different entity than the entity controlling the operation of the data processor. The plan asset value is a reflection of the current plan assets at the end of the predetermined period, and can include the actual value of the plan assets and/or a rate of return for the plan assets for the predetermined time period.

The method of this invention allows for review of a defined benefit plan throughout a plan year. Unlike a defined contribution plan which posts employee and employer contributions to an account, a defined benefit plan is based upon a future expectation of the employee and funded only by the employer. Complex calculations are used to determine the needed contributions, and annual reviews of the status of the defined benefit plan are typically performed annually at the end of each plan year. The method of this invention provides advantages of periodic reconciliation of the defined benefit plan throughout the plan year, providing periodic review of the plan assets and liabilities to avoid over- or under-funding surprises at the end of the plan year, in violation of the plan rules. In one preferred embodiment, the predetermined time period of the method is daily, such as at the end of each business day (i.e., the end of each day the financial markets are open). Daily reconciliation according to this invention provides asset review advantages of a defined contribution plan in a defined benefit plan, and the benefits thereof. Although daily operation and repetition of the steps of FIG. 1 may be preferred, the invention is not so limited, and can be operated on other periodic timeframes through the plan year, such as, without limitation, weekly, monthly, quarterly, etc.

After receiving the plan asset value, the data processor updates the plan information of the prior predetermined time period in box 24. In box 26, the data processor automatically tracks any difference between the plan asset value and allowed benefit values for participants of the defined benefit plan. The allowed benefit values are generally set according to the plan rules and tax laws. In one embodiment, the difference between the plan asset value and allowed benefit values can be a violation of plan rules and the difference cannot be allocated as a benefit credit to the plan participants. The difference can be an amount above a maximum or below a minimum allowed benefit value. In step 28, the difference can be automatically posted with the data processor as a deposit or addition to a side account 30 if the plan asset value is above a maximum allowed benefit value, or a withdrawal or subtraction from the side account 30 if additional funds are needed to make the minimum benefit value. The side account is not a participant account within the defined benefit plan that holds the difference to keep the participant benefit accruals, such as will be described further below, within the allowed benefit values of the plan rules.

In one embodiment of this invention, the data processor further receives payroll information, including information on any benefit distribution(s) paid to participants and contributions made into the plan assets. The payroll information can be received when receiving plan asset value in box 20 as shown in FIG. 1, or at any other time during the predetermined time period. The benefit distributions and contributions are actually taken from or added to the plan assets at the custodian 22, but the distribution or contribution values are reconciled and allocated by the data processor to within the account structure according to this invention. The value of benefit distributions are automatically applied as participant benefit debits and ultimately to the allowed benefit value. The contribution value can be allocated as participant benefit credits immediately, or, as in one embodiment of this invention, the contribution value can be posted to the side account 30 and withdrawn as needed to maintain an allowed benefit value for participants.

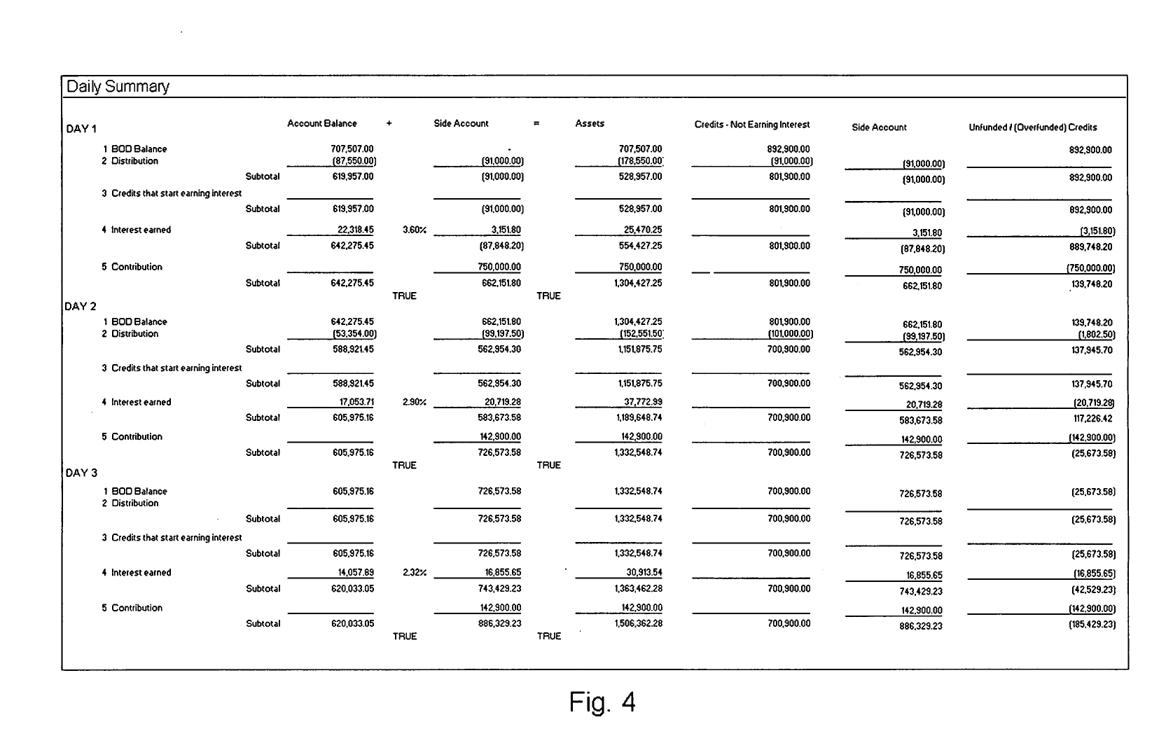

In box 32, the data processor automatically generates a graphical user interface display including value information of the plan assets and the side account. The user interface display can be viewed by the employer or other accounting personnel, such as on an associated monitor or mobile device, to monitor the defined benefit plan, and if necessary make one or more additional contributions. The graphical user interface display can be embodied as a spreadsheet, such as shown in FIG. 4, or any suitable display to communicate value information of the defined benefit account and the side account.

FIG. 2 illustrates a representative system for implementing the method according to one embodiment of the invention. In FIG. 2, the data processor 50 receives plan asset value information from the custodian 52, and any distribution or contribution information from the payroll or accounting department 54. According to one embodiment of this invention, the method provides an asset account 56, a side account 58, and for each participant a corresponding participant benefit account (PBA) 60. The asset account 56 is provided for posting plan asset value transactions or information, such as opening balances, inflows, outflows, and/or ending balances. For example, the data processor 50 can first reconcile and/or allocate the received plan asset value from the custodian 52 to the asset account 56.

In one embodiment of this invention, the participant benefit accounts 60 of this invention allow for automatic and daily reconciling of the defined benefit plan, while maintaining benefit values within the constraints of the plan rules. Each participant benefit account 60 corresponds to one of the plan participants, and includes a corresponding participant benefit value that includes at least an allocated portion of the plan assets. For each predetermined time period, the data processor 50 automatically adjusts a participant benefit value of each of the participant benefit accounts 60 as a function of the plan asset value for the predetermined time period. It is important to note that the participant benefit values can collectively be more than the plan asset value, such as due to negative investment returns, and the side account values and/or further contributions can be used to meet the difference.

The data processor automatically adjusts the participant benefit accounts 60 for benefit accruals, interest credits, and benefit distributions. In one embodiment of this invention, the allowed benefit value for the participants is individually tracked on an individual basis for each participant using the participant benefits accounts. For example, the data processor automatically daily determines if there is any difference in participant benefit values for each of the participant benefit account over or under an allowed benefit value for the corresponding participants according the defined benefit plan. The data processor automatically posting any determined difference, whether positive or negative, to the side account.

Distributions for a participant can be paid from the corresponding participant benefit account 60, and any distribution shortfall can be automatically drawn from the side account 58 by the data processor 50. In one embodiment of this invention, the data processor 50 receives a distribution request for a requesting participant. The data processor 50 determines the distribution amount if needed. The data processor 50 then automatically compares the distribution amount to a participant benefit value of the participant benefit account 60 for the requesting participant to determine any distribution shortfall between the distribution and the participant benefit value. The data processor 50 automatically posts the distribution shortfall to the side account 58. In one embodiment of this invention, the data processor 50 can further post any value left in a participant benefit account 60 to the side account 58, if needed according to plan requirements.

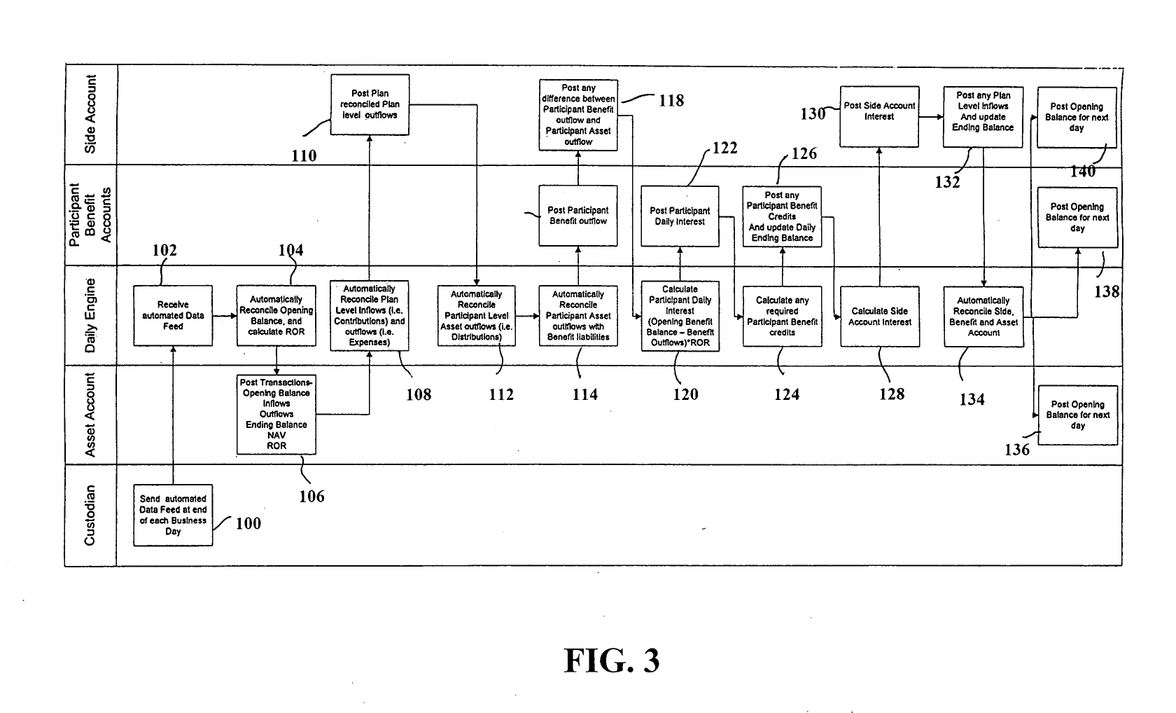

FIG. 3 is a flow diagram of the method according to another embodiment of this invention. In step 100, the custodian sends an automated data feed of plan asset value to the data processor at the end of a business day. The data processor receives the data feed in step 102 and calculates a rate of return in step 104 by comparing the plan asset value to the opening balance from the prior day. The data processor automatically updates the asset account value in step 106, In step 108, the data processor automatically reconciles any plan level inflows (e.g., contributions) and/or plan level outflows (e.g., expenses) and posts the reconciled amount to the side account in step 110.

In steps 112-116, the data processor automatically updates the participant benefit values of the participant benefit accounts as a function of the received plan asset value. In steps 112 and 114, the data processor reconciles any distribution against the allowed benefit values for each participant. In step 116, the distributions are posted as benefit outflows to the participant benefit accounts. Any difference between the benefit outflows and remaining participant benefit value in the participant benefit account is posted to the side account in step 118. In step 120, each participant's portion of the new plan asset value is determined by multiplying the daily rate of return from step 104 with the opening balance of each participant benefit account. The daily interest credit for each participant is posted to the corresponding participant benefit account in step 122. In step 124, the data processor determines any additional participant benefit credits and posts the credits to the corresponding participant benefit account in step 126.

In step 128, the rate of return is applied to the side account to determine a side account interest credit to post to the side account in step 130. In step 132, the contributions or other plan level inflows are posted to the side account. The data processor then reconciles the side account and asset account in step 134, and posts the next day opening balances for each of the asset account, the side account, and each participant benefit account in steps 136-140. The next day, the process is repeated upon receiving an updated plan asset value from the custodian.

FIG. 4 illustrates a possible graphical user interface display for monitoring the defined benefit plan according to one embodiment of this invention. FIG. 4 illustrates a daily summary of account values for the asset account, the side account, and the plan assets, thereby providing daily accounting of plan assets and surpluses or shortfalls. The graphical user interface of FIG. 4 is created and updated automatically by the data processor, and accessible to the plan owner and/or the accounting or actuarial person(s) monitoring the defined benefit plan.

Thus, the invention provides a method, and corresponding software, for daily reconciling and asset monitoring of a defined benefit plan. The method provides for daily accounting of the plan, and thus provides the benefits of a defined contribution plan.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A method of reconciling a defined benefit plan including plan assets and plan benefit liabilities, comprising:
receiving with a data processor a plan asset value at the end of a predetermined time period;
automatically tracking with the data processor a difference between the plan asset value and allowed benefit values for participants of the defined benefit plan;
automatically posting with the data processor the difference to a side account with the data processor.

2. The method of claim 1, wherein the plan asset value comprises a rate of return for the predetermined time period.

3. The method of claim 1, further comprising automatically repeating the receiving, tracking, and posting steps at a plurality of the predetermined time period during a plan year.

4. The method of claim 1, wherein the predetermined time period comprises a business day, and further comprising repeating the receiving, adjusting, tracking, and posting steps each business day.

5. The method of claim 1, further comprising automatically receiving a value of a benefit distribution to a participant of the defined benefit plan during the predetermined time period.

6. The method of claim 1, wherein automatically posting the difference to a side account comprises adding or withdrawing side account value.

7. The method of claim 1, further comprising automatically generating a user interface display including value information of the plan assets and the side account.

8. The method of claim 1, further comprising providing for each of the participants a corresponding participant benefit account including a corresponding participant benefit value comprising at least an allocated portion of the plan assets.

9. The method of claim 8, further comprising paying distributions for a participant from the corresponding participant benefit account and drawing distribution shortfalls from the side account.

10. The method of claim 8, further comprising automatically adjusting the participant benefit accounts for benefit accruals, interest credits, and benefit distributions.

11. The method of claim 8, further comprising automatically adjusting a participant benefit value of each of the participant benefit accounts as a function of the plan asset value for the predetermined time period.

12. The method of claim 8, further comprising:
automatically determining any difference of participant benefit values of each of the participant benefit account over or under an allowed benefit value for the participants according the defined benefit plan; and
automatically posting the any difference to the side account.

13. The method of claim 8, further comprising:
determining a distribution for a requesting participant;
automatically comparing the distribution to a participant benefit value of the participant benefit account for the requesting participant to determine any distribution shortfall between the distribution and the participant benefit value; and
automatically posting the distribution shortfall to the side account.

14. The method of claim 8, further comprising posting a contribution to the plan asset value.

15. A method of reconciling a defined benefit plan including plan assets and benefit liabilities, comprising:
providing for a participant a participant benefit account including a corresponding participant benefit value comprising at least an allocated portion of the plan assets;
receiving a plan asset value at an end of a predetermined time period with the data processor;
automatically updating the participant benefit value of the participant benefit value as a function of the received plan asset value;
automatically determining any difference of updated participant benefit value over or under an allowed benefit value for the participant according to the defined benefit plan; and
automatically posting the any difference from the participant benefit account to a side account.

16. The method of claim 15, wherein the predetermined time period is each business day.

17. The method of claim 15, further comprising automatically receiving and posting at least one of a contribution value or a distribution value for the participant to the participant benefit account.

18. The method of claim 15, further comprising:
providing a plurality of participant benefit accounts, each of the plurality of participant benefit accounts corresponding to one of a plurality of participants; and
automatically allocating the plan asset value between each of the plurality of participant benefit accounts.

19. The method of claim 15, wherein the plan asset value comprises a rate of return for the predetermined time period and automatically updating the participant value comprises increasing the participant value by the rate of return.

20. The method of claim 1, further comprising automatically reconciling plan level inflows including contributions and plan level outflows including expenses, and posting reconciled plan level outflows to the side account.
